(19) United States
(12) Patent Application Publication
(10) Pub. No.: US 2020/0307576 A1
(43) Pub. Date: Oct. 1, 2020

(54) DRIVER ASSISTANCE APPARATUS AND DRIVER ASSISTANCE METHOD

(71) Applicant: MITSUBISHI ELECTRIC CORPORATION, Tokyo (JP)

(72) Inventor: Yuki TAKEGAWA, Tokyo (JP)

(73) Assignee: MITSUBISHI ELECTRIC CORPORATION, Tokyo (JP)

(21) Appl. No.: 16/635,100

(22) PCT Filed: Sep. 8, 2017
(86) PCT No.: PCT/JP2017/032460

§ 371 Date: Jan. 29, 2020

(51) Int. Cl. B60W 30/12; B60W 50/14; G06K 9/00

(52) U.S. Cl. CPC B60W 30/12; B60W 50/14; B60W 2552/53; B60W 2050/146; G06K 9/00798

(57) ABSTRACT

It is an object of the present invention to provide a driver assistance apparatus and a driver assistance method. The driver assistance apparatus in accordance with the present invention includes a map information acquisition unit for acquiring map information including a lane shape, a lane shape correction unit for so correcting the lane shape as to coincide with a position of a lane which a driver of a vehicle can actually visually recognize in his visual field, and a display controller for performing control to so display an image of a virtual lane having the lane shape as to be superimposed on the lane which the driver can actually visually recognize in his visual field, and the display controller performs control to display the image of the virtual lane at least in a portion which the driver is impeded from actually visually recognizing in his visual field.

### TECHNICAL FIELD

The present invention relates to a driver assistance apparatus and a driver assistance method for assisting the driving of a driver.

### BACKGROUND ART

Conventionally, a technique has been disclosed, in which each of a plurality of spots on a road of a map and a travel road shape viewed in front from a viewpoint of a vehicle driver at the spot are associated with each other and stored and the travel road shape corresponding to a self-vehicle position is read out and displayed on a head up display (see, for example, Patent Document 1).

Further, another technique has been disclosed, in which a current position of a vehicle is specified and a shape of a road on which the vehicle is currently traveling is recognized by using a road map database, and a virtual lane in conformity with the recognized road shape is displayed on a head up display (see, for example, Patent Document 2).

### PRIOR ART DOCUMENTS

### Patent Documents

[Patent Document 1] Japanese Patent Application Laid Open Gazette No. 2000-211452

[Patent Document 2] Japanese Patent Application Laid Open Gazette No. 2007-122578

### SUMMARY

### Problem to be Solved by the Invention

Sometimes during driving of a vehicle, a lane ahead of the vehicle is hidden by a shielding object and a driver cannot see the lane. In such a case, it is helpful for the driver to recognize a shape of part of the lane which is hidden by the shielding object. In Patent Documents 1 and 2, however, there is no description on how to display a virtual lane with respect to the part of the lane which is hidden by the shielding object, and therefore the visibility of the lane for the driver is not good.

The present invention is intended to solve such a problem as above, and it is an object of the present invention to provide a driver assistance apparatus and a driver assistance method which make it possible to increase the visibility of a travel lane for a driver.

### Means to Solve the Problem

The present invention is intended for a driver assistance apparatus. In order to solve the above-described problem, according to the present invention, the driver assistance apparatus includes a map information acquisition unit for acquiring map information including a lane shape in a traveling direction of a vehicle, a lane shape correction unit for so correcting the lane shape acquired by the map information acquisition unit as to coincide with a position of a lane which a driver of the vehicle can actually visually recognize in his visual field, and a display controller for performing control to so display an image of a virtual lane having the lane shape corrected by the lane shape correction unit as to be superimposed on the lane which the driver can actually visually recognize in his visual field, and in the driver assistance apparatus, the display controller performs control to display the image of the virtual lane at least in a portion which the driver is impeded from actually visually recognizing in his visual field.

The present invention is also intended for a driver assistance method. According to the present invention, the driver assistance method includes acquiring map information including a lane shape in a traveling direction of a vehicle, so correcting the acquired lane shape as to coincide with a position of a lane which a driver of the vehicle can actually visually recognize in his visual field, and performing control to so display an image of a virtual lane having the corrected lane shape as to be superimposed on the lane which the driver can actually visually recognize in his visual field, and in the driver assistance method, the control is performed to display the image of the virtual lane at least in a portion which the driver is impeded from actually visually recognizing in his visual field.

### Effects of the Invention

According to the present invention, since the driver assistance apparatus includes a map information acquisition unit for acquiring map information including a lane shape in a traveling direction of a vehicle, a lane shape correction unit for so correcting the lane shape acquired by the map information acquisition unit as to coincide with a position of a lane which a driver of the vehicle can actually visually recognize in his visual field, and a display controller for performing control to so display an image of a virtual lane having the lane shape corrected by the lane shape correction unit as to be superimposed on the lane which the driver can actually visually recognize in his visual field, and the display controller performs control to display the image of the virtual lane at least on a portion which the driver is impeded from actually visually recognizing in his visual field, it is possible to increase the visibility of a travel lane for the driver.

Further, since the driver assistance method includes acquiring map information including a lane shape in a traveling direction of a vehicle, so correcting the acquired lane shape as to coincide with a position of a lane which a driver of the vehicle can actually visually recognize in his visual field, and performing control to so display an image of a virtual lane having the corrected lane shape as to be superimposed on the lane which the driver can actually visually recognize in his visual field, and the control is performed to display the image of the virtual lane at least in a portion which the driver is impeded from actually visually recognizing in his visual field, it is possible to increase the visibility of a travel lane for the driver.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an exemplary constitution of a driver assistance apparatus in accordance with a first preferred embodiment of the present invention;

FIG. 2 is a block diagram showing an exemplary constitution of the driver assistance apparatus in accordance with the first preferred embodiment of the present invention;

FIG. 3 is a block diagram showing an exemplary case where the driver assistance apparatus in accordance with the first preferred embodiment of the present invention is applied to a navigation device;

FIG. 4 is a block diagram showing an exemplary hardware constitution of the navigation device in accordance with the first preferred embodiment of the present invention;

FIG. 5 is a view showing an exemplary data structure of map information in accordance with the first preferred embodiment of the present invention;

FIG. 6 is a view showing an example of road network data in accordance with the first preferred embodiment of the present invention;

FIG. 7 is a view showing an exemplary relation between an actual road and the road network data in accordance with the first preferred embodiment of the present invention;

FIG. 8 is another view showing an exemplary relation between the actual road and the road network data in accordance with the first preferred embodiment of the present invention;

FIG. 9 is still another view showing an exemplary relation between the actual road and the road network data in accordance with the first preferred embodiment of the present invention;

FIG. 10 is a flowchart showing an exemplary operation of the driver assistance apparatus in accordance with the first preferred embodiment of the present invention;

FIG. 11 is a view showing an exemplary landscape which a driver is actually visually recognizing in his visual field in accordance with the first preferred embodiment of the present invention;

FIG. 12 is a view showing an exemplary display of a virtual lane in accordance with the first preferred embodiment of the present invention;

FIG. 13 is a view showing another exemplary landscape which the driver is actually visually recognizing in his visual field in accordance with the first preferred embodiment of the present invention;

FIG. 14 is a view showing another exemplary display of the virtual lane in accordance with the first preferred embodiment of the present invention;

FIG. 15 is a view showing still another exemplary landscape which the driver is actually visually recognizing in his visual field in accordance with the first preferred embodiment of the present invention;

FIG. 16 is a view showing still another exemplary display of the virtual lane in accordance with the first preferred embodiment of the present invention;

FIG. 17 is a view showing yet another exemplary landscape which the driver is actually visually recognizing in his visual field in accordance with the first preferred embodiment of the present invention;

FIG. 18 is a view showing yet another exemplary display of the virtual lane in accordance with the first preferred embodiment of the present invention;

FIG. 19 is a block diagram showing an exemplary constitution of a driver assistance apparatus in accordance with a second preferred embodiment of the present invention;

FIG. 20 is a block diagram showing an exemplary case where the driver assistance apparatus in accordance with the second preferred embodiment of the present invention is applied to a navigation device;

FIG. 21 is a flowchart showing an exemplary operation of the driver assistance apparatus in accordance with the second preferred embodiment of the present invention;

FIG. 22 is a view showing an exemplary display of a virtual lane in accordance with the second preferred embodiment of the present invention;

FIG. 23 is a view showing another exemplary display of the virtual lane in accordance with the second preferred embodiment of the present invention;

FIG. 24 is a flowchart showing an exemplary operation of a driver assistance apparatus in accordance with a third preferred embodiment of the present invention;

FIG. 25 is a view showing an exemplary landscape which the driver is actually visually recognizing in his visual field in accordance with the third preferred embodiment of the present invention;

FIG. 26 is a view showing an exemplary display of a virtual lane in accordance with the third preferred embodiment of the present invention;

FIG. 27 is a block diagram showing an exemplary constitution of a driver assistance apparatus in accordance with a fourth preferred embodiment of the present invention;

FIG. 28 is a block diagram showing an exemplary case where the driver assistance apparatus in accordance with the fourth preferred embodiment of the present invention is applied to a navigation device;

FIG. 29 is a flowchart showing an exemplary operation of the driver assistance apparatus in accordance with the fourth preferred embodiment of the present invention;

FIG. 30 is a view showing an exemplary display of a virtual lane in accordance with the fourth preferred embodiment of the present invention;

FIG. 31 is a flowchart showing an exemplary operation of a driver assistance apparatus in accordance with a fifth preferred embodiment of the present invention; and

FIG. 32 is a block diagram showing an exemplary constitution of a driver assistance system in accordance with the preferred embodiments of the present invention.

### DESCRIPTION OF EMBODIMENT(S)

With reference to figures, the preferred embodiments of the present invention will be discussed below.

### The First Preferred Embodiment

<Constitution>

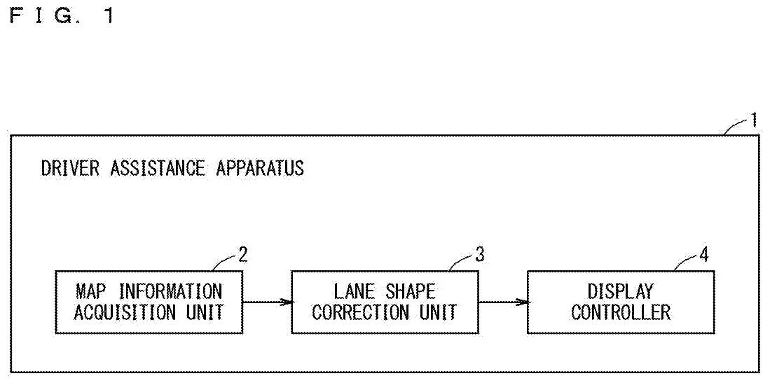

FIG. 1 is a block diagram showing an exemplary constitution of a driver assistance apparatus 1 in accordance with the first preferred embodiment of the present invention. Further, FIG. 1 shows requisite minimum constituent elements constituting the driver assistance apparatus of the present first preferred embodiment.

As shown in FIG. 1, the driver assistance apparatus 1 comprises a map information acquisition unit 2, a lane shape correction unit 3, and a display controller 4. The map information acquisition unit 2 acquires map information including a lane shape in a traveling direction of a vehicle. The lane shape correction unit 3 so corrects the lane shape acquired by the map information acquisition unit 2 as to coincide with a position of a lane which a driver of the vehicle can actually visually recognize in his visual field. The display controller 4 performs control to so display an image of a virtual lane having the lane shape corrected by the lane shape correction unit 3 as to be superimposed on the lane which the driver can actually visually recognize in his visual field. Further, the display controller 4 performs control to display the image of the virtual lane at least in a portion which the driver is impeded from actually visually recognizing in his visual field.

Next, another constitution of the driver assistance apparatus including the driver assistance apparatus 1 of FIG. 1 will be described.

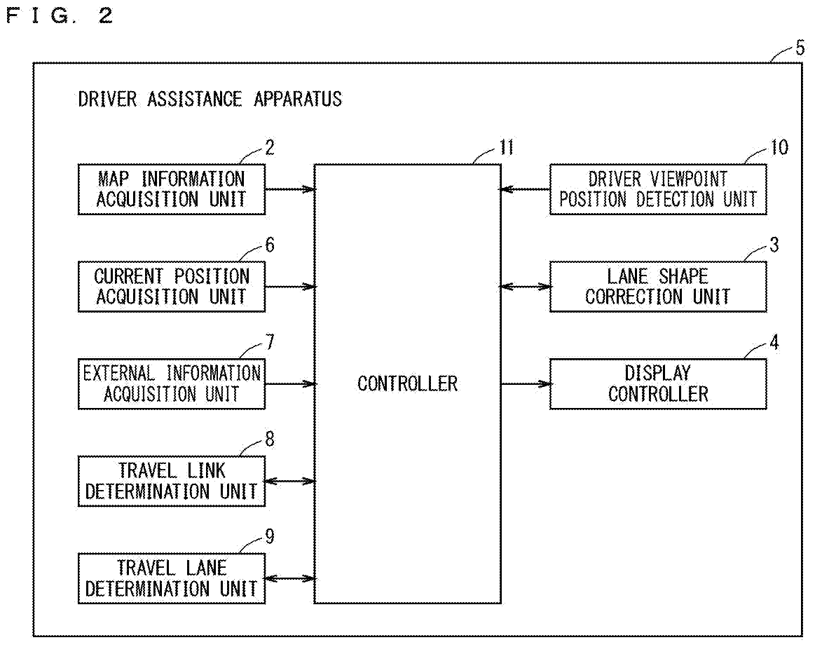

FIG. 2 is a block diagram showing an exemplary constitution of a driver assistance apparatus 5 having another constitution. As shown in FIG. 2, the driver assistance apparatus 5 comprises the map information acquisition unit 2, the lane shape correction unit 3, the display controller 4, a current position acquisition unit 6, an external information acquisition unit 7, a travel link determination unit 8, a travel lane determination unit 9, a driver viewpoint position detection unit 10, and a controller 11. Further, detailed description of these constituent elements will be made later.

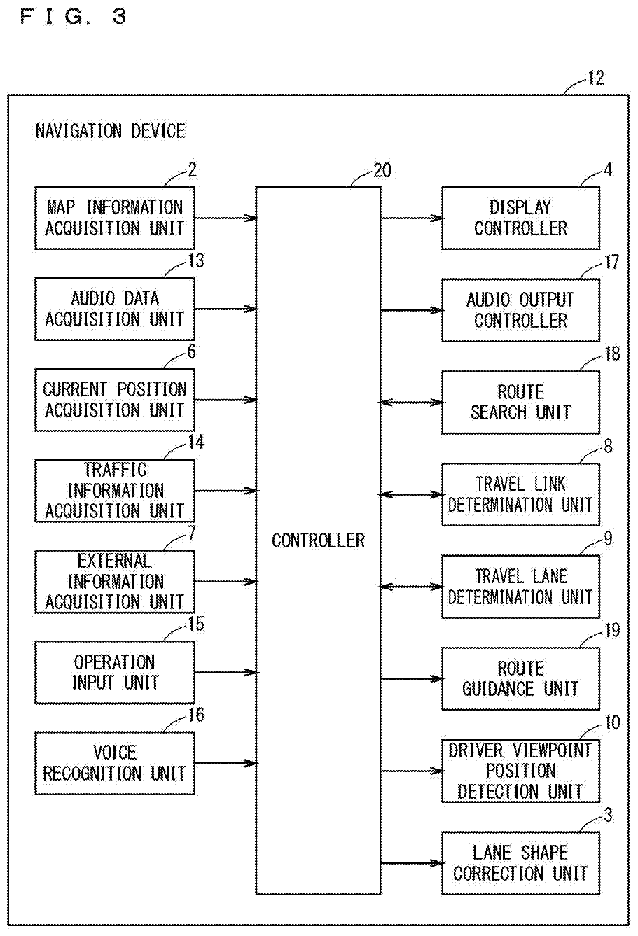

FIG. 3 is a block diagram showing an exemplary case where the driver assistance apparatus 5 is applied to a navigation device 12. As shown in FIG. 3, the navigation device 12 comprises the map information acquisition unit 2, the lane shape correction unit 3, the display controller 4, the current position acquisition unit 6, the external information acquisition unit 7, the travel link determination unit 8, the travel lane determination unit 9, the driver viewpoint position detection unit 10, an audio data acquisition unit 13, a traffic information acquisition unit 14, an operation input unit 15, a voice recognition unit 16, an audio output controller 17, a route search unit 18, a route guidance unit 19, and a controller 20.

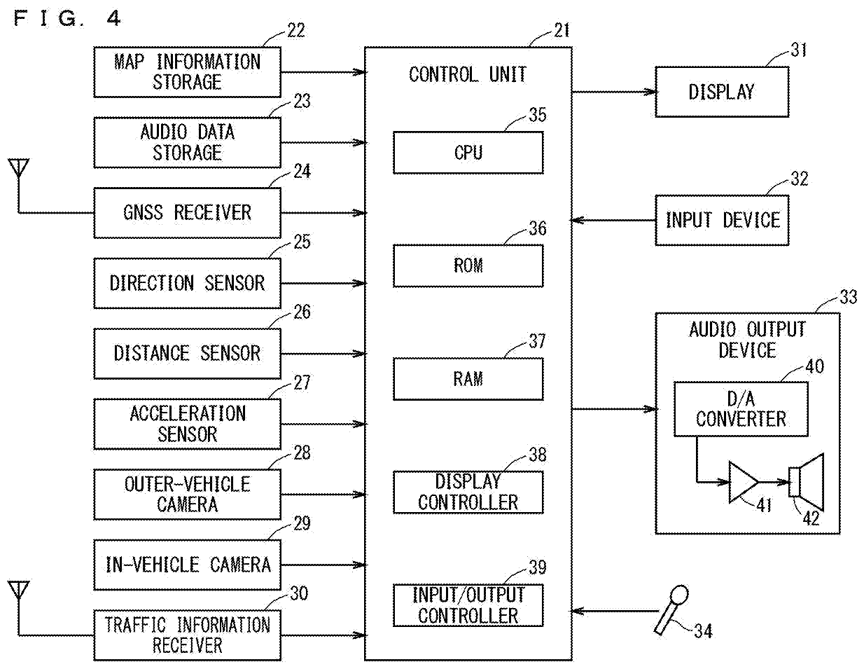

FIG. 4 is a block diagram showing an exemplary hardware constitution of the navigation device 12. As shown in FIG. 4, the navigation device 12 comprises a control unit 21, a map information storage 22, an audio data storage 23, a Global Navigation Satellite System (GNSS) receiver 24, a direction sensor 25, a distance sensor 26, an acceleration sensor 27, an outer-vehicle camera 28, an in-vehicle camera 29, a traffic information receiver 30, a display 31, an input device 32, an audio output device 33, and a microphone 34. The control unit 21 comprises a Central Processing Unit (CPU) 35, a Read Only Memory (ROM) 36, a Random Access Memory (RAM) 37, a display controller 38, and an input/output controller 39. The audio output device 33 comprises a Digital/Analog (D/A) converter 40, an amplifier 41, and a speaker 42.

The map information acquisition unit 2 acquires the map information including the lane shape in the traveling direction of the vehicle from the map information storage 22 and gives the acquired map information to the controller 20. The map information storage 22 is formed of a memory device such as a hard disk drive (HDD), a DVD and a unit for driving the DVD, a semiconductor memory, or the like. The map information storage 22 may be included in the navigation device 12 or may be provided outside the navigation device 12. In a case where the map information storage 22 is provided outside the navigation device 12, the map information acquisition unit 2 acquires the whole of or part of the map information from the map information storage 22 via a communication network. The map information acquisition unit 2 may hold therein the acquired map information or may store the map information into a not-shown storage unit.

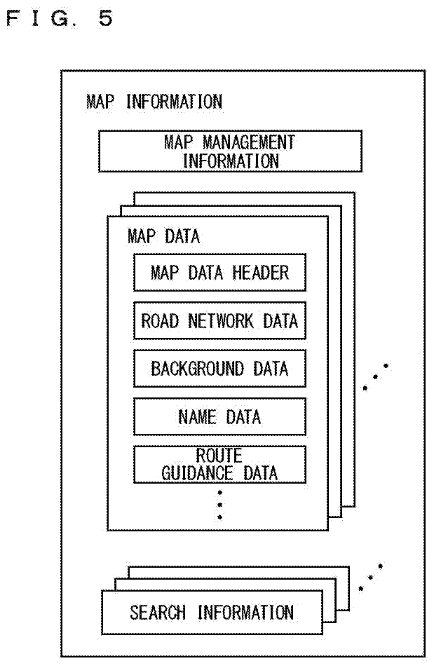

Herein, the map information stored in the map information storage 22 will be described. FIG. 5 is a view showing an exemplary data structure of the map information.

As shown in FIG. 5, the map information includes map management information, map data, and search information. The map management information includes, for example, version information indicating the version of the map information, hierarchical management information for managing the map data for each hierarchy, and search management information for managing various search information. The hierarchical management information has information such as a mesh number corresponding to each mesh, a storage location of the map data in the map information, data size, or the like for each hierarchy.

The map data include a map data header, road network data, background data, name data, route guidance data, or the like, and are hierarchized in accordance with the degree of details of the information. Further, the map data are provided corresponding to the mesh of each hierarchy. The search information includes information used to search for various information on a city, a road, a facility, an address, a phone number, an intersection, or the like.

The map data header include information to manage each data in the map data. The road network data include information indicating a road network. The road network is represented by using a node representing an intersection, a branch or a spot on the road, a road link representing a road connecting the nodes, and lane information of each road. The background data include plane data representing a river, a sea, or the like, line data representing a river, a railroad, or the like each of which is linear, and point data representing a facility symbol or the like. The name data include road name information representing a road name, place name information representing a place name, and background name information representing a name of a river, a sea, a facility symbol, or the like. The route guidance data include information required for route guidance at an intersection or the like.

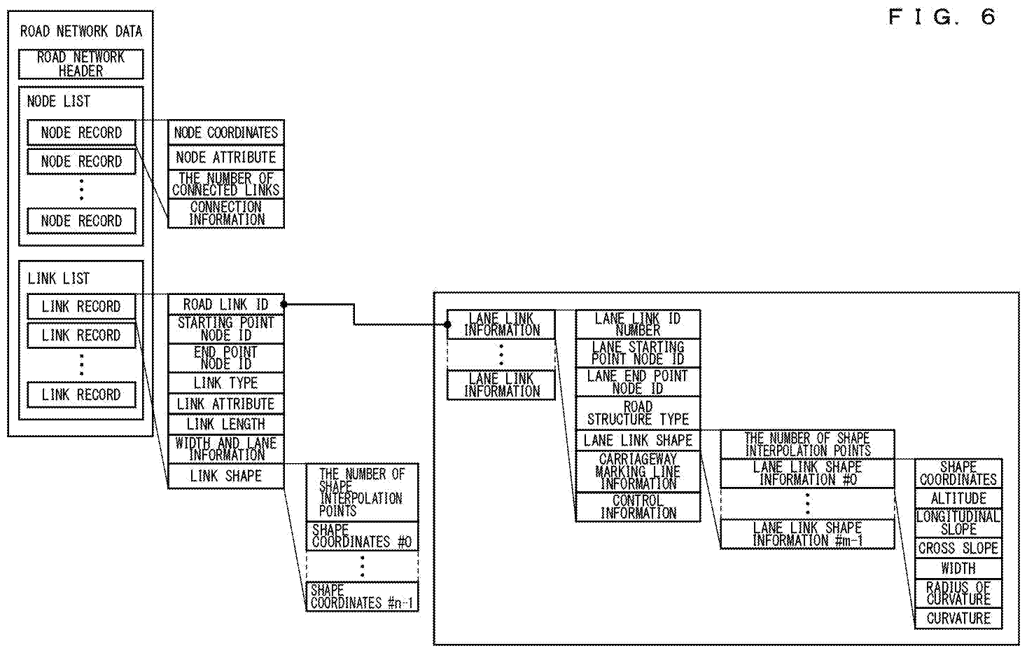

FIG. 6 is a view showing an example of the road network data included in the map information.

As shown in FIG. 6, the road network data include a road network header, a node list, a link list. The road network header includes information required to manage the road network data, such as the number of nodes and the number of links which are present in each mesh, the number of ID management records, a storage location and data size of each list, a storage location and data size of each table, or the like.

The node list is data on the nodes which are present in each mesh, and is constituted of node records provided corresponding to the nodes, respectively. The alignment order of the node records in the node list is a node ID. The node ID is in one-to-one correspondence with each node in the mesh and used to identify each node in the mesh. Each node record includes node coordinates representing a geographic location of each node by the longitude and latitude, a node attribute indicating whether each node is an intersection or a boundary node, or the like, the number of connected links indicating the number of links connected to each node, connection information indicating a link ID of the link connected to each node in the mesh, or the like.

The link list is data on the links which are present in each mesh, and is constituted of link records provided corresponding to the links, respectively. Each of the link records includes a road link ID used to identify each link in the mesh, a starting point node ID indicating a node ID of a starting point node which is a node on a starting point side of the link, an end point node ID indicating a node ID of an end point node which is a node on an end point side of the link, a link type representing a type of the link, a link attribute representing any one of various attributes on the link, such as a road type of the link, an average travel time, traffic restrictions, a speed limit, or the like, a link length representing the length of the link, the width/lane information representing the width and the number of lanes of the link, and a link shape representing a road shape of the link.

The link shape is data representing a road shape of the link, and includes the number of shape interpolation points and a shape coordinates list. The number of shape interpolation points represents the number of shape interpolation points which are vertices of the road shape of the link that is represented by a polygonal line. In a case where the road shape is a straight line connecting the starting point node and the end point node, the number of shape interpolation points is “0”. The shape coordinates list is a list in which the coordinates of the shape interpolation points which are vertices of the road shape of the link that is represented by a polygonal line are aligned. The shape interpolation point does not include the starting point node or the end point node. The coordinates of the shape interpolation point represent the geographic location by the longitude and latitude. Further, the coordinates of the shape interpolation point may be represented by the relative longitude and latitude from the preceding shape interpolation point. In this case, the coordinates of the first shape interpolation point are represented by the relative longitude and latitude from the starting point of the link. Furthermore, the link shape may be represented by an interpolation line, instead of the interpolation points.

Each road link includes the corresponding lane link information. The lane link information includes a lane link ID used to identify a lane link for each lane of the road link, a lane starting point node ID indicating a node ID of the starting point node which is a node on the starting point side of the lane link, a lane end point node ID indicating a node ID of the end point node which is a node on the end point side of the lane link, a road structure type representing a road structure type of the lane link, a lane link shape representing a link shape of the lane link, carriageway marking line information indicating a line type of the carriageway marking line of the lane or a pavement marking type, and control information indicating the traffic restrictions or the speed limit of the lane link. The road structure type indicates the structure of the road including the lane, and is classified into a normal lane, a branch lane, a merging lane, a climbing lane, a bus lane, an High-Occupancy Vehicle (HOV) lane, or the like, in accordance with the road structure. The carriageway marking line information is data indicating information on the carriageway marking line of the lane, and includes the color type or the line type of the carriageway marking line such as a white point line, a white solid line, a yellow solid line, or the like, a pavement marking type such as a deceleration sign or the like, a shape of the carriageway marking line, which is a lane shape, or the like.

The lane link shape is data representing a shape of the lane link, and includes the number of shape interpolation points and a lane link shape information list. The number of shape interpolation points represents the number of shape interpolation points which are vertices of the shape of the lane link that is represented by a polygonal line. The lane link shape information list includes the coordinates of the shape interpolation points which are vertices of the shape of the lane link that is represented by a polygonal line, and an altitude. Further, the lane link shape information list includes a longitudinal slope, a cross slope, a width, a radius of curvature, and a curvature at the shape interpolation point. The cross slope is a slope between the shape interpolation points.

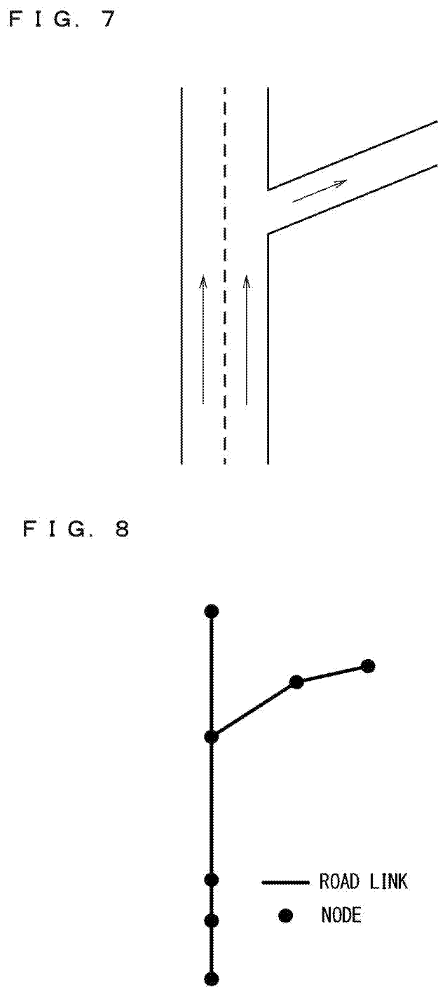

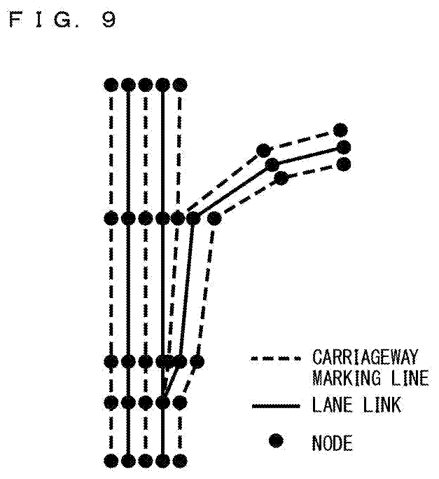

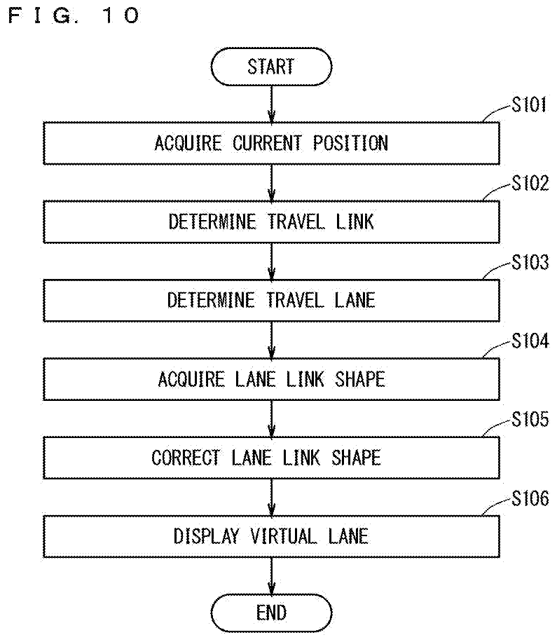

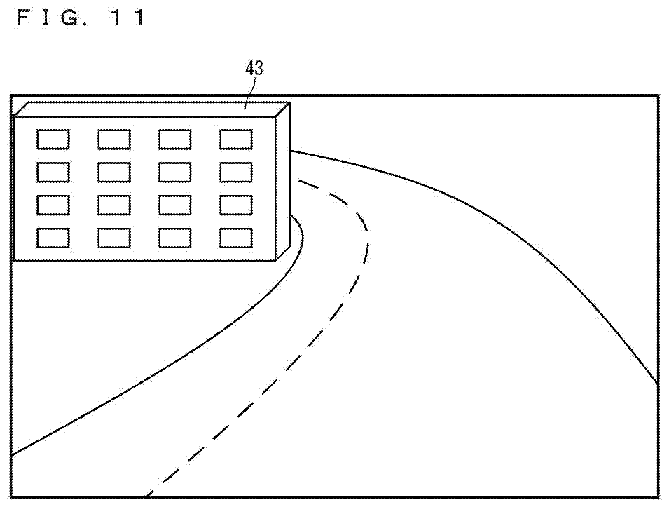

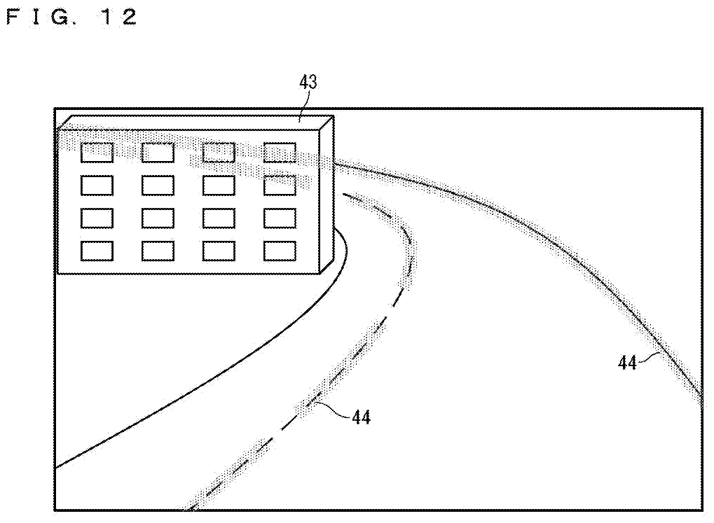

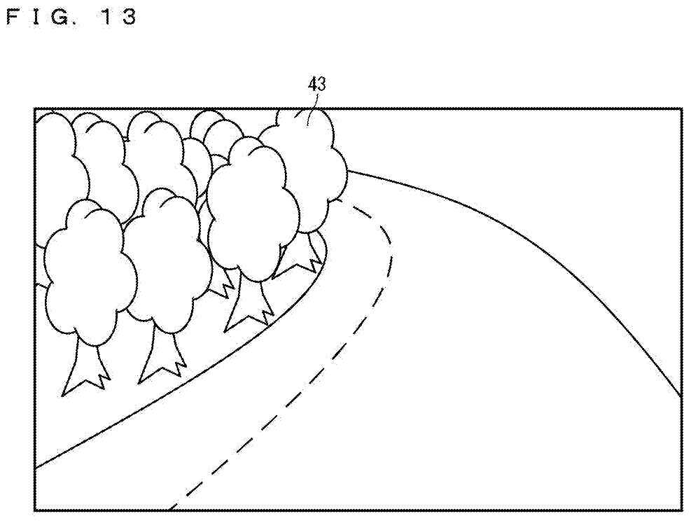

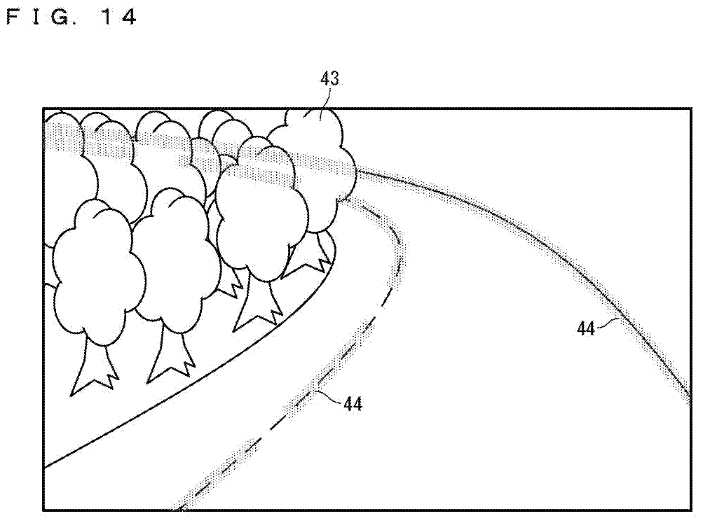

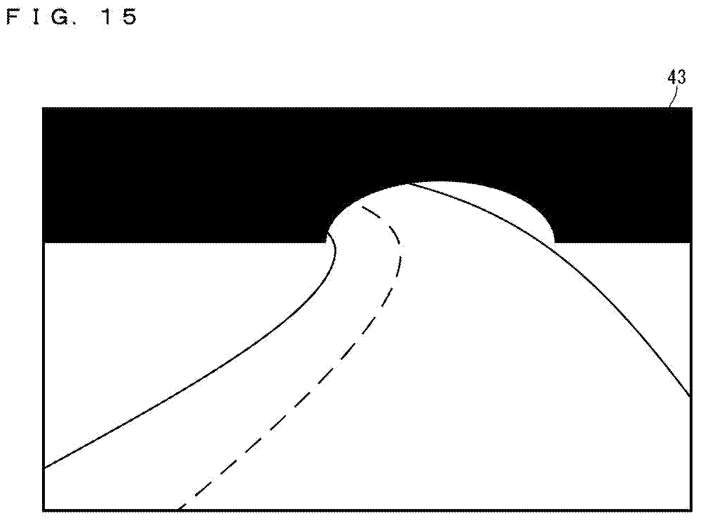

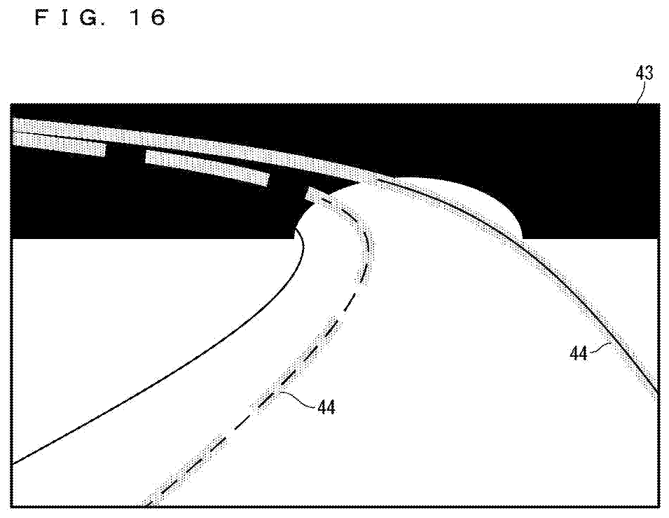

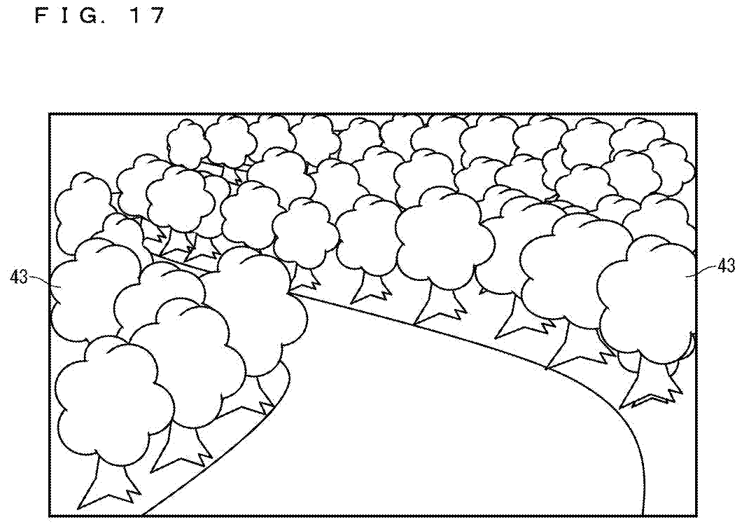

FIGS. 7 to 9 are views each showing an exemplary relation between an actual road and the road network data. FIG. 7 shows an example of the actual road. The road has two lanes, and one of these lanes is connected to a road which branches out in the midcourse in the right direction. Further, the arrows in this figure represent the traveling direction of the vehicle.

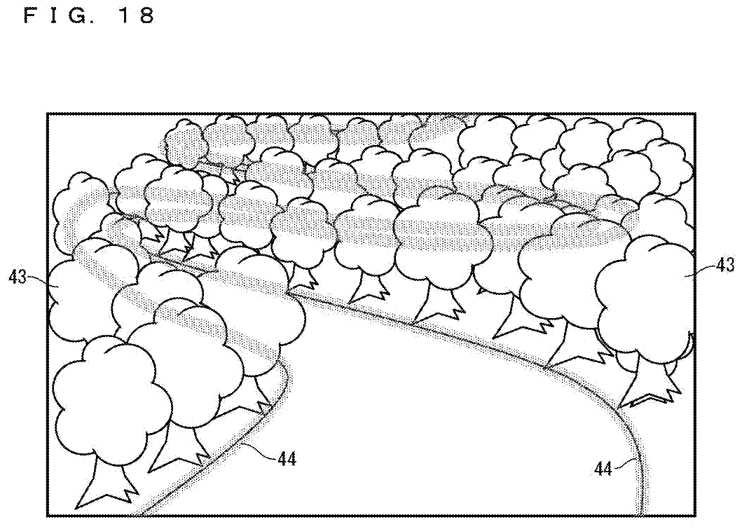

FIG. 8 represents the road of FIG. 7 by the road link and the nodes. As shown in FIG. 8, though the actual road has two lanes, the road is represented by one road link. The road link is represented along a center of the actual road.

FIG. 9 represents the road of FIG. 7 by the lane links and the nodes. As shown in FIG. 9, when the actual road has two lanes, each lane is represented by one lane link. The lane link is represented along a center of the actual lane. Further, the carriageway marking line represented by the broken line in this figure defines the lane on the actual road.

With reference back to FIGS. 3 and 4, the audio data acquisition unit 13 acquires audio data from the audio data storage 23, and gives the acquired audio data to the controller 20. The audio data storage 23 is formed of a memory device such as a hard disk drive (HDD), a DVD and a unit for driving the DVD, a semiconductor memory, or the like. The audio data storage 23 may be included in the navigation device 12 or may be provided outside the navigation device 12. The audio data storage 23 stores therein audio guide messages or the like to be used by the route guidance unit 19 for performing a route guidance using voice and sound. The audio guide messages are separated into a standard voice which is stored for each type of audio guide and a word voice which is stored as a specific content such as a distance, a place name, or the like. By combining the standard voice and the word voice, it is possible to obtain a desired voice. The audio data acquisition unit 13 may hold therein the acquired audio data or may store the audio data into a not-shown storage.

The current position acquisition unit 6 acquires a current position of the vehicle on the basis of position information received from a Global Navigation Satellite System (GNSS) receiver 24, a direction of the vehicle which is detected by the direction sensor 25, a travel distance of the vehicle which is detected by the distance sensor 26, and an acceleration of the vehicle which is detected by the acceleration sensor 27, and gives the acquired current position of the vehicle to the controller 20. The GNSS receiver 24 receives a radio wave transmitted from a Global Positioning System (GPS) satellite or the like and performs positioning of the current position of the vehicle in which the GNSS receiver 24 is set. The current position acquisition unit 6 acquires a positioning result such as a position, a direction, a speed, or the like from the GNSS receiver 24. The direction sensor 25 detects a direction of the vehicle on the basis of an angular velocity measured at every predetermined cycle. The current position acquisition unit 6 acquires the direction of the vehicle from the direction sensor 25. The distance sensor 26 acquires a pulse signal in accordance with a travel distance of the vehicle and detects the travel distance of the vehicle on the basis of the acquired pulse signal. The current position acquisition unit 6 acquires the travel distance of the vehicle from the distance sensor 26. The acceleration sensor 27 detects an angular velocity of the vehicle in a sensor coordinate system at every predetermined cycle. The current position acquisition unit 6 acquires the acceleration of the vehicle from the acceleration sensor 27.

The traffic information acquisition unit 14 acquires traffic information from the traffic information receiver 30, and gives the acquired traffic information to the controller 20. The traffic information receiver 30 is, for example, an FM multiplex receiver, a beacon receiver, a Traffic Message Channel (TMC) receiver, or the like, and receives the traffic information from the outside. The traffic information includes, for example, traffic jam information, construction information, and the like.

The external information acquisition unit 7 acquires external information from the outer-vehicle camera 28, and gives the acquired external information to the controller 20. The outer-vehicle camera 28 includes, for example, a front camera provided to be capable of imaging a front area in the traveling direction of the vehicle and a rear camera provided to be capable of imaging a rear area in the traveling direction of the vehicle. The external information acquisition unit 7 performs image processing of the image acquired from the outer-vehicle camera 28, to thereby acquire information on a travel lane on the road on which the vehicle is traveling, information on a shielding object which impedes actual visual recognition of the driver in his visual field, information on a road sign, information on an obstacle which impedes the traveling of the vehicle, information on the brightness outside the vehicle, or the like, as the external information. The information on a travel lane includes a color, a position, and a shape of the travel lane. The information on a shielding object includes whether there is a shielding object or not, a position and a color of the shielding object. Further, though the case has been described herein where the external information acquisition unit 7 acquires the external information from the outer-vehicle camera 28, this is only one exemplary case. There may be a case, for example, where an external sensor such as a laser radar or the like is set as well as the outer-vehicle camera 28 and the external information acquisition unit also acquires information obtained from the external sensor as the external information.

The operation input unit 15 receives an input operation of a user. The user performs an input operation by using the input device 32, to thereby give various instructions such as an input of a destination during the route search, a change of a screen to be displayed on the display 31, or the like. The operation input unit 15 gives the instruction obtained through the input operation of the user to the controller 20. As the input device 32, for example, used is a touch panel, a remote control, or the like.

The voice recognition unit 16 checks the voice inputted by the user through a microphone 34 by consulting a dictionary for voice recognition to recognize the voice and gives the instruction in accordance with the recognized voice to the controller 20.

The display controller 4 performs control to display various information on the display 31 in accordance with the instruction from the controller 20. The display 31 includes, for example, a liquid crystal display and a head up display (HUD). For example, the display controller 4 performs control to so display an image of a virtual lane having the lane shape corrected by the lane shape correction unit 3 as to be superimposed on the lane which the driver can actually visually recognize in his visual field, on the display 31 which is the head up display. At that time, the display controller 4 performs control to display the image of the virtual lane at least in a portion which the driver is impeded from actually visually recognizing in his visual field, on the display 31 which is the head up display. Further, the display controller 4 performs control to display a road map, a current position mark, a destination mark, or the like on the display 31 which is the liquid crystal display. Furthermore, the display controller 4 of FIG. 3 corresponds to the display controller 38 of FIG. 4.

The audio output controller 17 controls the audio output device 33 to output the voice and sound in accordance with the instruction from the controller 20. The audio output device 33 outputs, for example, a voice of the route guidance information, or the like in accordance with the instruction from the audio output controller 17. The audio output device 33 comprises the D/A converter 40 for converting digital signal data of the voice into an analog signal, the amplifier 41 for amplifying the voice which is converted into the analog signal, and the speaker 42 for outputting the amplified voice.

In accordance with the instruction from the controller 20, the route search unit 18 searches for a route from the current position of the vehicle acquired by the current position acquisition unit 6 to the destination received by the operation input unit 15 on the basis of the map information acquired by the map information acquisition unit 2. The route search unit 18 may hold therein the route which is found or may store the route into a not-shown storage. The route which is searched for by the route search unit 18 includes, for example, a time priority route which is a route that makes it possible to reach the destination within a short time of arrival, a distance priority route which is a route having a short travel distance from the current position to the destination, a fuel priority route which is a route that makes it possible to reach the destination from the current position with less fuel to be consumed, a toll road priority route which is a route on which a toll road is used as much as possible, a general road priority route which is a route on which a general road is used as much as possible, a standard route which is a route with a good balance of time, distance, and cost, or the like.

In accordance with the instruction from the controller 20, the route guidance unit 19 guides the vehicle from the current position to the destination by giving guidance along the route which is searched for by the route search unit 18 with a display or a voice.

In accordance with the instruction from the controller 20, the travel link determination unit 8 determines the travel link which is a road link on which the vehicle is currently traveling. Specifically, the travel link determination unit 8 determines the travel link which is a road link on which the vehicle is currently traveling on the basis of the current position of the vehicle which is acquired by the current position acquisition unit 6 and the road network data included in the map information acquired by the map information acquisition unit 2.

In accordance with the instruction from the controller 20, the travel lane determination unit 9 determines the travel lane which is a lane on which the vehicle is currently traveling. Specifically, the travel lane determination unit 9 determines the travel lane which is a lane on which the vehicle is currently traveling on the basis of the travel link determined by the travel link determination unit 8, the lane information of the road link included in the map information acquired by the map information acquisition unit 2, and the image picked up by the front camera which is the outer-vehicle camera 28. Further, when the accuracy of the position included in the position information received by the GNSS receiver 24 is high, the current position acquired by the current position acquisition unit 6 may be used.

The driver viewpoint position detection unit 10 performs image processing of the image picked up by the in-vehicle camera 29, to thereby detect a position of the eyes of the driver of the vehicle. The in-vehicle camera 29 is set inside the vehicle so that at least the eyes of the driver can be imaged.

The lane shape correction unit 3 so corrects the shape of the carriageway marking line which is the lane shape included in the map information acquired by the map information acquisition unit 2 as to coincide with a position of the lane which the driver of the vehicle can actually visually recognize in his visual field. Specifically, the lane shape correction unit 3 so corrects the shape of the carriageway marking line which is the lane shape included in the map information as to coincide with the position of the lane which the driver of the vehicle can actually visually recognize in his visual field on the basis of the shape of the carriageway marking line which is the lane shape included in the map information acquired by the map information acquisition unit 2, the travel lane determined by the travel lane determination unit 9, and the position of the eyes of the driver which is detected by the driver viewpoint position detection unit 10. This correction may be performed by using the well-known technique as disclosed in, for example, Patent Document 1.

The control unit 21 performs a general control of the navigation device 12. Respective functions of the map information acquisition unit 2, the lane shape correction unit 3, the display controller 4, the current position acquisition unit 6, the external information acquisition unit 7, the travel link determination unit 8, the travel lane determination unit 9, the driver viewpoint position detection unit 10, the audio data acquisition unit 13, the traffic information acquisition unit 14, the operation input unit 15, the voice recognition unit 16, the audio output controller 17, the route search unit 18, and the route guidance unit 19 in the navigation device 12 are implemented by the CPU 35. Specifically, the navigation device 12 comprises the CPU 35 to acquire the map information, correct the lane shape, control a display, acquire the current position, acquire the external information, determine the travel link, determine the travel lane, detect the driver viewpoint position, acquire the audio data, acquire the traffic information, receive the input operation of the user, recognize the voice, control the output of the voice, search for the route, and perform a route guidance. Herein, the CPU 35 is sometimes referred to as a processing unit, an arithmetic unit, a microprocessor, a microcomputer, or a Digital Signal Processor (DSP).

Respective functions of the map information acquisition unit 2, the lane shape correction unit 3, the display controller 4, the current position acquisition unit 6, the external information acquisition unit 7, the travel link determination unit 8, the travel lane determination unit 9, the driver viewpoint position detection unit 10, the audio data acquisition unit 13, the traffic information acquisition unit 14, the operation input unit 15, the voice recognition unit 16, the audio output controller 17, the route search unit 18, and the route guidance unit 19 in the navigation device 12 are implemented by software, firmware, or combination of software and firmware. Software or firmware is described as the program and stored into the Read Only Memory (ROM) 36 or the Random Access Memory (RAM) 37 which is a memory. The CPU 35 reads and executes the program stored in the ROM 36 or the RAM 37, to thereby implement the respective functions of the constituent elements. Specifically, the navigation device 12 comprises the ROM 36 or the RAM 37 to store therein the programs to be used to consequently perform a step of acquiring the map information, a step of correcting the lane shape, a step of controlling a display, a step of acquiring the current position, a step of acquiring the external information, a step of determining the travel link, a step of determining the travel lane, a step of detecting the driver viewpoint position, a step of acquiring the audio data, a step of acquiring the traffic information, a step of receiving the input operation of the user, a step of recognizing the voice, a step of controlling the output of the voice, a step of searching for the route, and a step of performing a route guidance. These programs are executed to cause a computer to perform a procedure or a method of the map information acquisition unit 2, the lane shape correction unit 3, the display controller 4, the current position acquisition unit 6, the external information acquisition unit 7, the travel link determination unit 8, the travel lane determination unit 9, the driver viewpoint position detection unit 10, the audio data acquisition unit 13, the traffic information acquisition unit 14, the operation input unit 15, the voice recognition unit 16, the audio output controller 17, the route search unit 18, and the route guidance unit 19. Herein, the memory is not limited to the ROM 36 or the RAM 37 but may be a nonvolatile or volatile semiconductor memory such as a flash memory, an Erasable Programmable Read Only Memory (EPROM), an Electrically Erasable Programmable Read Only Memory (EEPROM), or the like, a magnetic disk, a flexible disk, an optical disk, a compact disk, a mini disk, a DVD, or the like, or every storage medium to be used in the future.

The input/output controller 39 controls input/output of data between the control unit 21 and the map information storage 22, the audio data storage 23, the GNSS receiver 24, the direction sensor 25, the distance sensor 26, the acceleration sensor 27, the outer-vehicle camera 28, the in-vehicle camera 29, the traffic information receiver 30, the input device 32, the audio output device 33, and the microphone 34.

The navigation device 12 has only to comprise at least the control unit 21. The navigation device 12 may comprise all or some of the map information storage 22, the audio data storage 23, the GNSS receiver 24, the direction sensor 25, the distance sensor 26, the acceleration sensor 27, the outer-vehicle camera 28, the in-vehicle camera 29, the traffic information receiver 30, the input device 32, the audio output device 33, and the microphone 34.

Further, though FIG. 4 shows the hardware constitution of the navigation device 12, the driver assistance apparatus 5 shown in FIG. 2 comprises a CPU and a memory to perform the respective functions.

<Operation>

FIG. 10 is a flowchart showing an exemplary operation of the driver assistance apparatus 5.

In Step S101, the current position acquisition unit 6 acquires the current position of the vehicle. Specifically, the current position acquisition unit 6 acquires the current position of the vehicle on the basis of the position information received from the GNSS receiver 24, the direction of the vehicle which is detected by the direction sensor 25, the travel distance of the vehicle which is detected by the distance sensor 26, and the acceleration of the vehicle which is detected by the acceleration sensor 27.

In Step S102, the travel link determination unit 8 determines the travel link which is a road link on which the vehicle is currently traveling. Specifically, the travel link determination unit 8 determines the travel link which is a road link on which the vehicle is currently traveling on the basis of the current position of the vehicle which is acquired by the current position acquisition unit 6 and the road network data which the map information acquisition unit 2 acquires from the map information storage 22.

In Step S103, the travel lane determination unit 9 determines the travel lane which is a lane on which the vehicle is currently traveling. Specifically, the travel lane determination unit 9 determines the travel lane which is a lane on which the vehicle is currently traveling on the basis of the travel link determined by the travel link determination unit 8, the lane information of the road link which the map information acquisition unit 2 acquires from the map information storage 22, and the image picked up by the front camera which is the outer-vehicle camera 28.

In Step S104, the map information acquisition unit 2 acquires, from the map information storage 22, the shape of the carriageway marking line which is the lane shape of the travel lane determined by the travel lane determination unit 9.

In Step S105, the lane shape correction unit 3 so corrects the shape of the carriageway marking line which is the lane shape acquired by the map information acquisition unit 2 as to coincide with the position of the lane which the driver of the vehicle can actually visually recognize in his visual field. Specifically, the lane shape correction unit 3 so corrects the shape of the carriageway marking line which is the lane shape as to coincide with the position of the lane which the driver of the vehicle can actually visually recognize in his visual field on the basis of the shape of the carriageway marking line which is the lane shape acquired by the map information acquisition unit 2, the travel lane determined by the travel lane determination unit 9, and the position of the eyes of the driver which is detected by the driver viewpoint position detection unit 10.

In Step S106, the display controller 4 performs control to so display the image of the virtual lane having the lane shape corrected by the lane shape correction unit 3 as to be superimposed on the lane which the driver can actually visually recognize in his visual field, on the display 31 which is the head up display. At that time, the display controller 4 performs control to display the image of the virtual lane at least in a portion which the driver is impeded from actually visually recognizing in his visual field, on the display 31 which is the head up display.

Further, though the above description has been made on the operation of the driver assistance apparatus 5, the navigation device 12 to which the driver assistance apparatus 5 is applied also performs the same operation.

The operation of FIG. 10 may start when an engine of the vehicle is turned on or may start in accordance with the instruction of the user.

<Display Example>

Hereinafter, Display Examples 1 to 4 of the virtual lane in Step S106 of FIG. 10 will be described.

<Display Example 1>

FIG. 11 is a view showing an exemplary landscape which the driver is actually visually recognizing in his visual field. Further, it is assumed that the vehicle is traveling on a right lane.

As shown in FIG. 11, part of the travel lane of the vehicle is hidden by a shielding object 43 which is a building. Specifically, a portion which the driver is impeded from actually visually recognizing in his visual field corresponds to a portion in which the travel lane is hidden by the shielding object 43 which is the building. In such a situation, the display controller 4 displays a virtual lane 44 as shown in FIG. 12 on the head up display. The virtual lane 44 is displayed, being superimposed on the actual travel lane and also on the shielding object 43.

From the above description, it is possible for the driver to easily recognize the shape of the travel lane in the portion in which the travel lane is hidden by the shielding object 43 which is the building. Therefore, the driver can drive the vehicle while considering the shape of the travel lane in the portion in which the travel lane is hidden by the shielding object 43 which is the building.

<Display Example 2>

FIG. 13 is a view showing another exemplary landscape which the driver is actually visually recognizing in his visual field. Further, it is assumed that the vehicle is traveling on the right lane.

As shown in FIG. 13, part of the travel lane of the vehicle is hidden by a shielding object 43 which is a clump of trees. Specifically, a portion which the driver is impeded from actually visually recognizing in his visual field corresponds to a portion in which the travel lane is hidden by the shielding object 43 which is the clump of trees. In such a situation, the display controller 4 displays a virtual lane 44 as shown in FIG. 14 on the head up display. The virtual lane 44 is displayed, being superimposed on the actual travel lane and also on the shielding object 43.

From the above description, it is possible for the driver to easily recognize the shape of the travel lane in the portion in which the travel lane is hidden by the shielding object 43 which is the clump of trees. Therefore, the driver can drive the vehicle while considering the shape of the travel lane in the portion in which the travel lane is hidden by the shielding object 43 which is the building.

<Display Example 3>

FIG. 15 is a view showing still another exemplary landscape which the driver is actually visually recognizing in his visual field. Further, it is assumed that the vehicle is traveling on the right lane.

As shown in FIG. 15, part of the travel lane of the vehicle is hidden by a shielding object 43 which is a tunnel. Specifically, a portion which the driver is impeded from actually visually recognizing in his visual field corresponds to a portion in which the travel lane is hidden by the shielding object 43 which is the tunnel. In such a situation, the display controller 4 displays a virtual lane 44 as shown in FIG. 16 on the head up display. The virtual lane 44 is displayed, being superimposed on the actual travel lane and also on the shielding object 43.

From the above description, it is possible for the driver to easily recognize the shape of the travel lane in the portion in which the travel lane is hidden by the shielding object 43 which is the tunnel. Therefore, the driver can drive the vehicle while considering the shape of the travel lane in the portion in which the travel lane is hidden by the shielding object 43 which is the tunnel.

<Display Example 4>

FIG. 17 is a view showing yet another exemplary landscape which the driver is actually visually recognizing in his visual field.

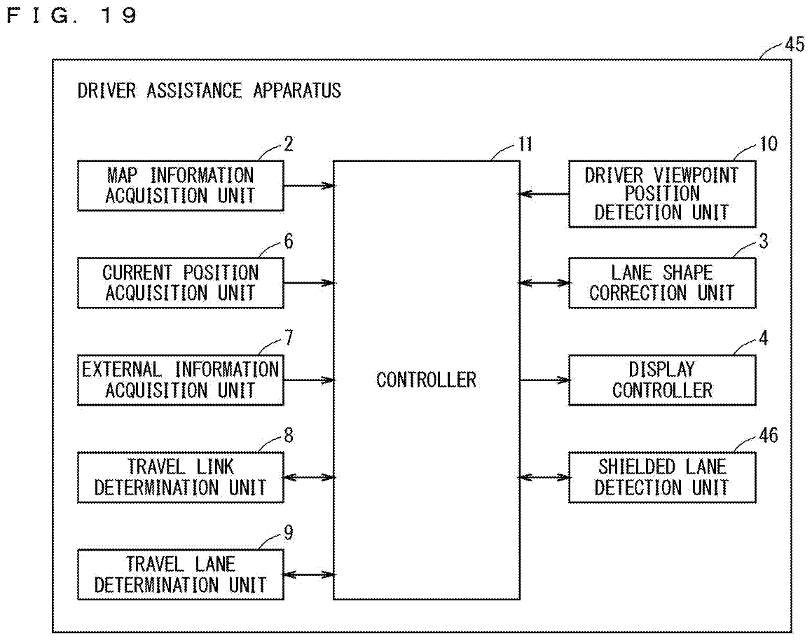

As shown in FIG. 17, part of the travel lane of the vehicle is hidden by a shielding object 43 which is a forest. Specifically, a portion which the driver is impeded from actually visually recognizing in his visual field corresponds to a portion in which the travel lane is hidden by the shielding object 43 which is the forest. In such a situation, the display controller 4 displays a virtual lane 44 as shown in FIG. 18 on the head up display. The virtual lane 44 is displayed, being superimposed on the actual travel lane and also on the shielding object 43.

From the above description, it is possible for the driver to easily recognize the shape of the travel lane in the portion in which the travel lane is hidden by the shielding object 43 which is the forest. Therefore, the driver can drive the vehicle while considering the shape of the travel lane in the portion in which the travel lane is hidden by the shielding object 43 which is the forest.

Further, though description has been made on a case where the virtual lane 44 is displayed, being superimposed on each of both sides of the travel lane in the above Display Examples 1 to 4, the display of the virtual lane 44 is not limited to this. For example, the virtual lane which fills part of or the whole of an area inside the travel lane may be displayed only if the shape of the travel lane including a portion hidden by the shielding object can be seen. Furthermore, the virtual lane may be displayed only in the portion hidden by the shielding object.

As described above, according to the first preferred embodiment, not only in a portion which the driver can actually visually recognize in his visual field, but also in another portion which the driver is impeded by the shielding object from actually visually recognizing, the virtual lane is displayed, being superimposed on the actual travel lane, on the head up display. It is thereby possible for the driver to easily recognize the shape of the travel lane in the portion in which the travel lane is hidden by the shielding object. Therefore, the driver can drive the vehicle while considering the shape of the travel lane in the portion in which the travel lane is hidden by the shielding object. In other words, it becomes possible to increase the visibility of the travel lane for the driver.

Further, in the case where the driver assistance apparatus is applied to the navigation device, it is possible for the driver to easily grasp the shape of the travel lane in a portion on a route, which is hidden by a shielding object.

### The Second Preferred Embodiment

<Constitution>

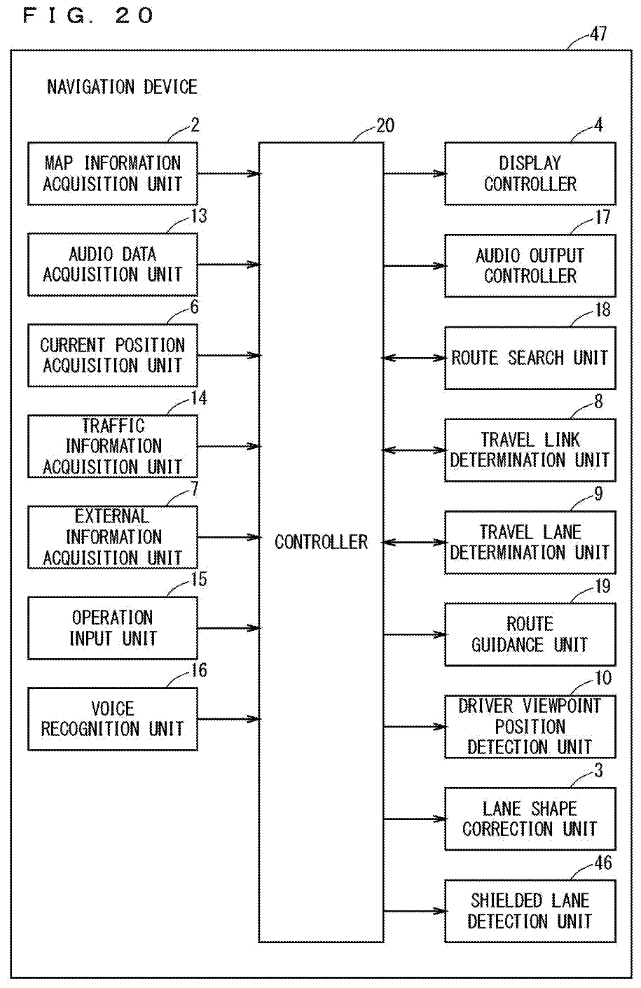

FIG. 19 is a block diagram showing an exemplary constitution of a driver assistance apparatus 45 in accordance with the second preferred embodiment of the present invention. FIG. 20 is a block diagram showing an exemplary case where the driver assistance apparatus 45 is applied to a navigation device 47. As shown in FIGS. 19 and 20, as the characteristic feature of the second preferred embodiment, a shielded lane detection unit 46 is further provided. Since the constituent elements other than the above are identical to those in the driver assistance apparatus 5 of the first preferred embodiment, detailed description thereof will be omitted herein. Further, since the hardware constitution of the navigation device 47 is identical to that of the navigation device 12 in the first preferred embodiment, detailed description thereof will be omitted herein.

The shielded lane detection unit 46 detects a portion of the travel lane, which the driver cannot visually recognize due to a shielding object. Specifically, the shielded lane detection unit 46 detects the portion of the travel lane, which the driver cannot visually recognize due to a shielding object, on the basis of the lane shape corrected by the lane shape correction unit 3 and the position of the shielding object acquired by the external information acquisition unit 7.

The function of the shielded lane detection unit 46 is implemented, for example, by the CPU 35 shown in FIG. 4. Further, in the ROM 36 or the RAM 37, stored is a program to be used to consequently perform a step of detecting the portion of the travel lane, which the driver cannot visually recognize due to a shielding object.

<Operation>

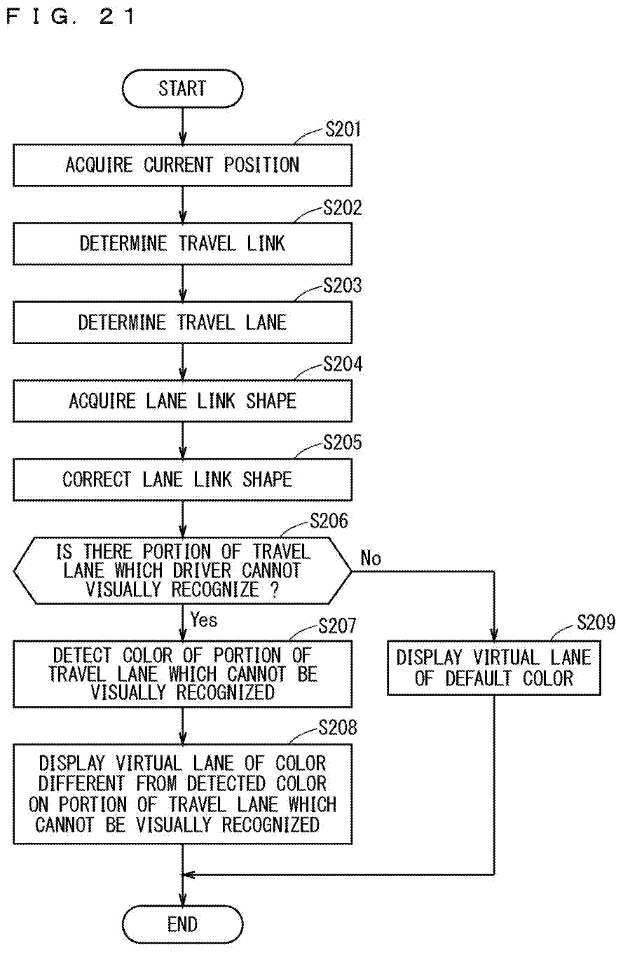

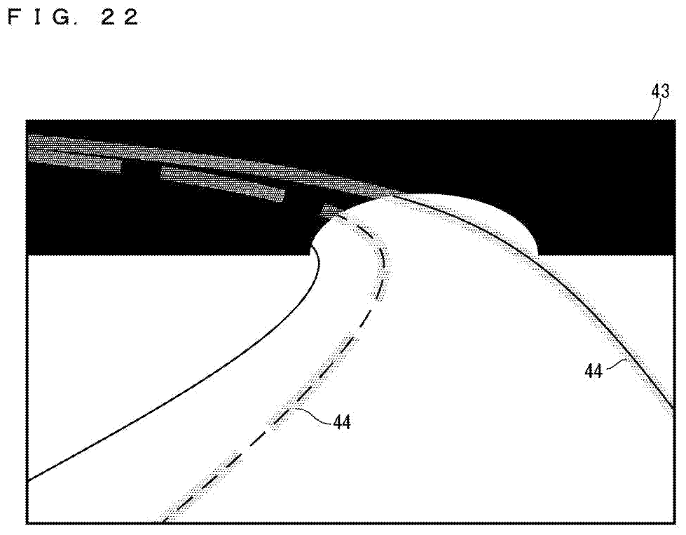

FIG. 21 is a flowchart showing an exemplary operation of the driver assistance apparatus 45. Further, since Steps S201 to S205 in FIG. 21 are the same as Steps S101 to S105 in FIG. 10, description thereof will be omitted herein. Hereinafter, Steps S206 to S209 will be described.

In Step S206, the shielded lane detection unit 46 determines whether or not there is a portion of the travel lane, which the driver cannot visually recognize due to a shielding object. Specifically, the shielded lane detection unit 46 detects the portion of the travel lane, which the driver cannot visually recognize due to a shielding object, on the basis of the lane shape which is corrected by the lane shape correction unit 3 and the position of the shielding object which is acquired by the external information acquisition unit 7. When there is a portion of the travel lane which the driver cannot visually recognize due to a shielding object, the process goes to Step S207. On the other hand, when there is no portion of the travel lane which the driver cannot visually recognize due to a shielding object, the process goes to Step S209.

In Step S207, the controller 11 detects a color of the shielding object which impedes the driver from visually recognizing the travel lane. The color of the shielding object detected herein is a color of the shielding object which is acquired by the external information acquisition unit 7.

In Step S208, the display controller 4 performs control to display an image of a virtual lane having a color different from the color of the shielding object which is detected in Step S207 in the portion of the travel lane which the driver cannot visually recognize due to the shielding object on the head up display. Specifically, as shown in FIG. 22, in a case where the shielding object 43 which is a tunnel hides the travel lane, for example, the display controller 4 performs control to so display the virtual lane 44 having a color different from the color of the shielding object 43 as to be superimposed on the shielding object 43 which is the tunnel. Further, though FIG. 22 shows a case where the color of the virtual lane displayed in a portion which is not hidden by the shielding object 43 is a default color which is set in advance, this is only one exemplary case. For example, the color of the virtual lane displayed in the portion which is not hidden by the shielding object 43 may be the same color as that of the virtual lane displayed, being superimposed on the shielding object 43. In this case, the color of the virtual lane displayed, being superimposed on the shielding object 43, is different from that of the shielding object 43. Further, the color different from that of the shielding object 43 may be a complementary color of the color of the shielding object 43.

In Step S209, the display controller 4 performs control to display the image of the virtual lane having a default color on the head up display.

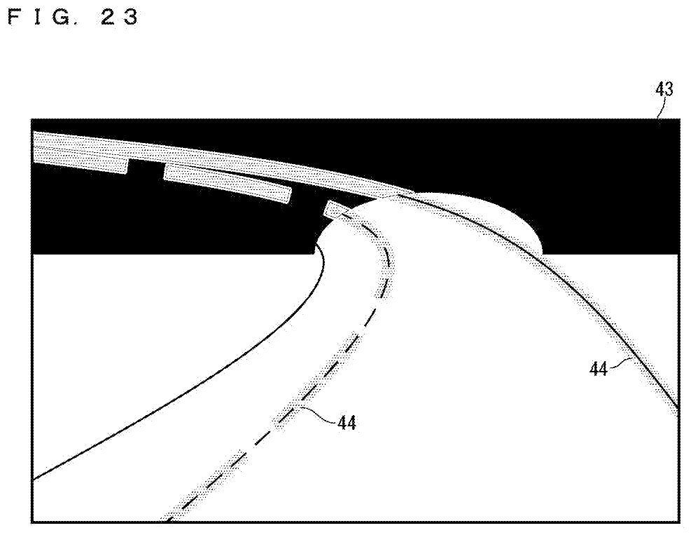

Further, though description has been made on the case where the virtual lane having a color different from that of the shielding object is displayed, being superimposed on the shielding object in the above Step S208, the display of the virtual lane is not limited to this. As shown in FIG. 23, for example, the display controller 4 may perform control to display the virtual lane 44 on the head up display so that a color rimming the virtual lane 44 which is displayed, being superimposed on the shielding object 43 which is the tunnel, should be different from the color of the shielding object 43. Furthermore, the display controller 4 may control the transmittance of a color of the virtual lane which is displayed, being superimposed on the shielding object, to be different from that of the virtual lane displayed in the other area.

Further, though the above description has been made on the operation of the driver assistance apparatus 45, the navigation device 47 to which the driver assistance apparatus 45 is applied also performs the same operation.

The operation of FIG. 21 may start when an engine of the vehicle is turned on or may start in accordance with the instruction of the user.

As described above, according to the second preferred embodiment, the image of the virtual lane having a color different from the color of the shielding object which is present in the portion of the travel lane which the driver cannot visually recognize due to the shielding object is displayed on the head up display. It is thereby possible for the driver to easily recognize the shape of the travel lane in the portion in which the travel lane is hidden by the shielding object. Especially, in the case where the color of the shielding object is the same as that of the virtual lane, the driver cannot easily recognize the virtual lane which is displayed, being superimposed on the shielding object, but according to the second preferred embodiment, this problem can be solved. Therefore, the driver can drive the vehicle while considering the shape of the travel lane in the portion in which the travel lane is hidden by the shielding object. In other words, it becomes possible to increase the visibility of the travel lane for the driver.

Further, in the case where the driver assistance apparatus is applied to the navigation device, it is possible for the driver to easily grasp the shape of the travel lane in a portion on a route, which is hidden by a shielding object.

### The Third Preferred Embodiment

<Constitution>

As the characteristic feature of the third preferred embodiment, when it is dark outside the vehicle, the color of the virtual lane displayed on the head up display is luminescent color. Since respective constitutions of the driver assistance apparatus and the navigation device to which the driver assistance apparatus is applied in accordance with the third preferred embodiment are identical to those in the first preferred embodiment, description thereof will be omitted herein. Hereinafter, description will be made, assuming that the driver assistance apparatus and the navigation device in the third preferred embodiment are the driver assistance apparatus 5 and the navigation device 12 in the first preferred embodiment.

<Operation>

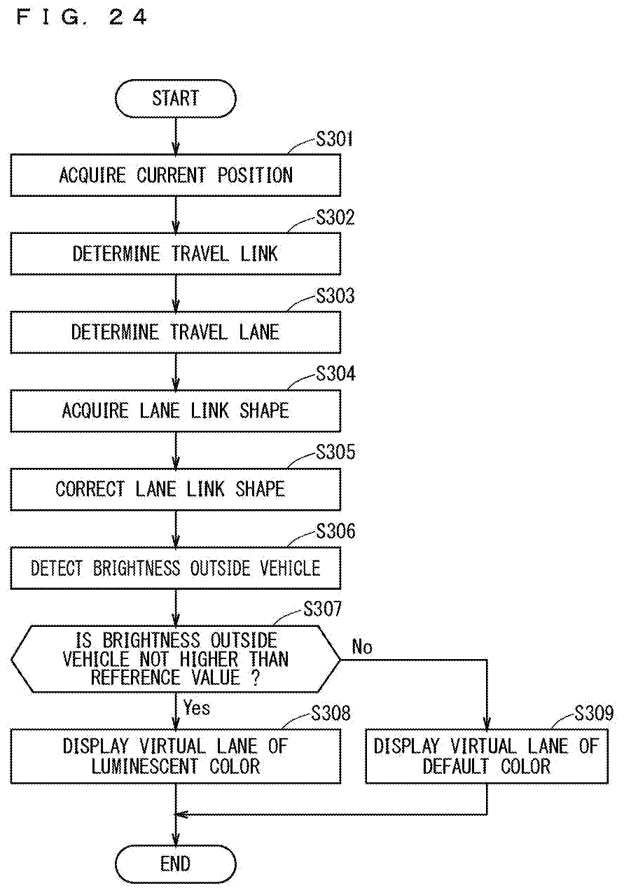

FIG. 24 is a flowchart showing an exemplary operation of the driver assistance apparatus 5 in the third preferred embodiment. Further, since Steps S301 to S305 in FIG. 24 are the same as Steps S101 to S105 in FIG. 10, description thereof will be omitted herein. Hereinafter, Steps S306 to S309 will be described.

In Step S306, the controller 11 detects the brightness outside the vehicle. Herein, the brightness outside the vehicle to be detected is information on the brightness outside the vehicle, which is acquired by the external information acquisition unit 7. The information on the brightness outside the vehicle, which is acquired by the external information acquisition unit 7, may be information obtained by performing image processing of the image picked up by the outer-vehicle camera 28, or may be the brightness outside the vehicle, which is detected by a not-shown luminance sensor.

In Step S307, the controller 11 determines whether or not the brightness outside the vehicle is not higher than a reference value. Herein, the situation where the brightness outside the vehicle is not higher than the reference value includes, for example, night, bad weather, the inside of a tunnel, or the like. When the brightness outside the vehicle is not higher than the reference value, the process goes to Step S308. On the other hand, when the brightness outside the vehicle is higher than the reference value, the process goes to Step S309.

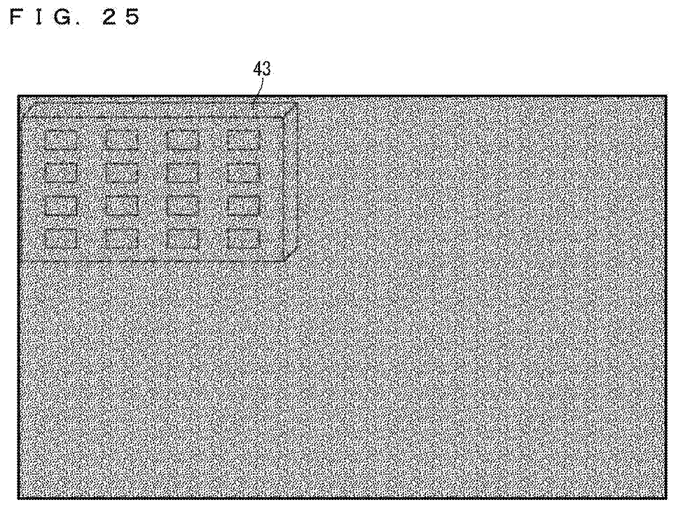

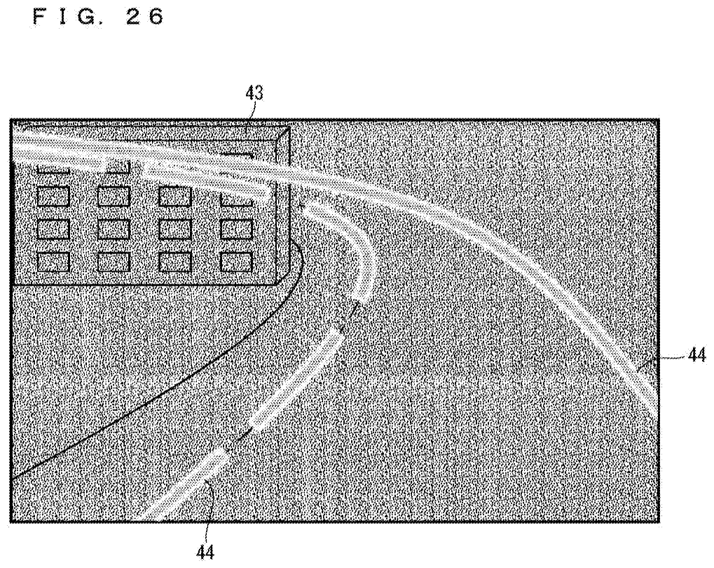

In Step S308, the display controller 4 performs control to display an image of the virtual lane of luminescent color on the head up display. Specifically, when it is dark outside the vehicle, as shown in FIG. 25, the display controller 4 performs control to display the virtual lane 44 of luminescent color as shown in FIG. 26. In this case, when there is a shielding object 43 which hides the travel lane, the virtual lane 44 of luminescent color is displayed, being superimposed on the shielding object 43.

In Step S309, the display controller 4 performs control to display an image of the virtual lane of default color on the head up display. In this case, when there is a shielding object which hides the travel lane, the virtual lane of default color is displayed, being superimposed on the shielding object.

Further, though the above description has been made on the operation of the driver assistance apparatus 5, the navigation device 12 to which the driver assistance apparatus 5 is applied also performs the same operation.

The operation of FIG. 24 may start when an engine of the vehicle is turned on or may start in accordance with the instruction of the user.

As described above, according to the third preferred embodiment, when it is dark outside the vehicle, the image of the virtual lane of luminescent color is displayed on the head up display. It is thereby possible for the driver to easily recognize the shape of the travel lane in the portion in which the travel lane is hidden by the shielding object even when it becomes dark outside the vehicle. Therefore, the driver can drive the vehicle while considering the shape of the travel lane in the portion in which the travel lane is hidden by the shielding object. In other words, it becomes possible to increase the visibility of the travel lane for the driver.

Further, in the case where the driver assistance apparatus is applied to the navigation device, it is possible for the driver to easily grasp the shape of the travel lane in a portion on a route, which is hidden by a shielding object.

Furthermore, though the third preferred embodiment has been described above by using the driver assistance apparatus 5 and the navigation device 12 in the first preferred embodiment, the third preferred embodiment can be also applied to the second preferred embodiment.

### The Fourth Preferred Embodiment

<Constitution>

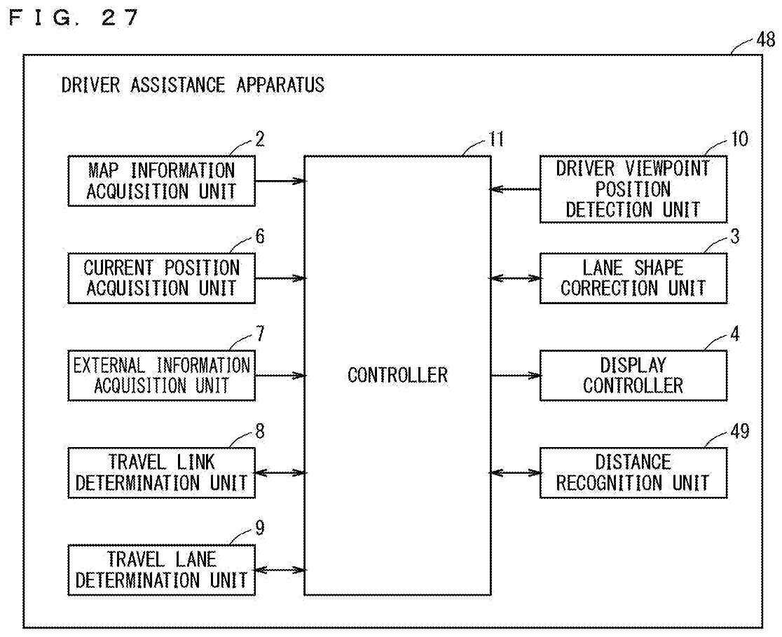

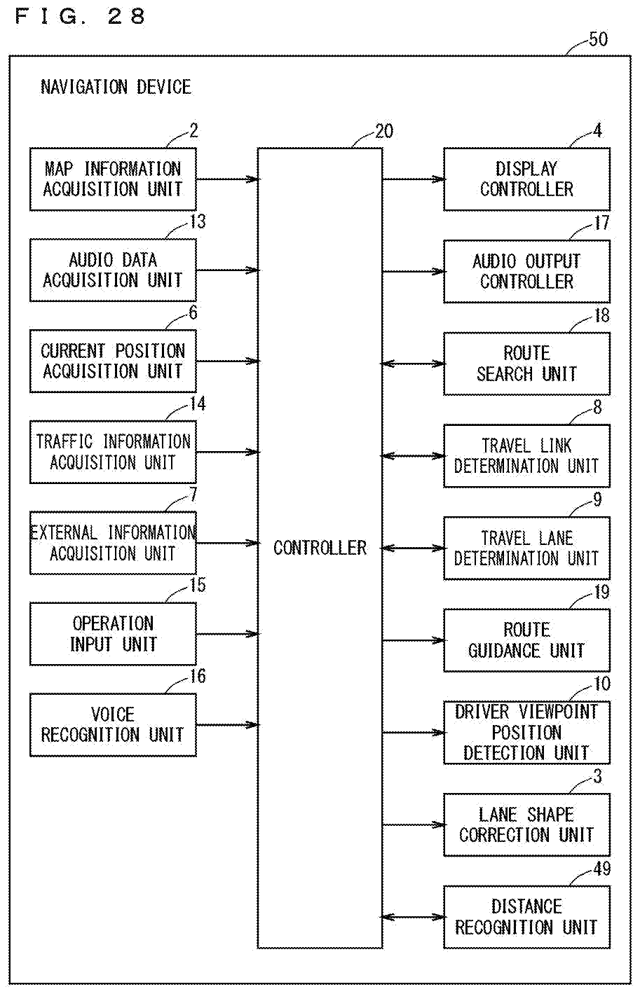

FIG. 27 is a block diagram showing an exemplary constitution of a driver assistance apparatus 48 in accordance with the fourth preferred embodiment of the present invention. FIG. 28 is a block diagram showing an exemplary case where the driver assistance apparatus 48 is applied to a navigation device 50. As shown in FIGS. 27 and 28, as the characteristic feature of the fourth preferred embodiment, a distance recognition unit 49 is further provided. Since the constituent elements other than the above are identical to those in the driver assistance apparatus 5 of the first preferred embodiment, detailed description thereof will be omitted herein. Further, since the hardware constitution of the navigation device 50 is identical to that of the navigation device 12 in the first preferred embodiment, detailed description thereof will be omitted herein.

The distance recognition unit 49 recognizes a distance between the current position of the vehicle and the travel lane. Specifically, the distance recognition unit 49 recognizes the distance between the current position of the vehicle and the travel lane on the basis of the current position acquired by the current position acquisition unit 6 and the position of the travel lane acquired by the external information acquisition unit 7. In this case, the distance between the current position of the vehicle and the travel lane may be recognized at every certain distance. Further, the position of the travel lane can be obtained by performing image processing of the image picked up by the outer-vehicle camera 28, but may be obtained by other methods.

The function of the distance recognition unit 49 is implemented, for example, by the CPU 35 shown in FIG. 4. Further, in the ROM 36 or the RAM 37, stored is a program to be used to consequently perform a step of recognizing the distance between the current position of the vehicle and the travel lane.

<Operation>

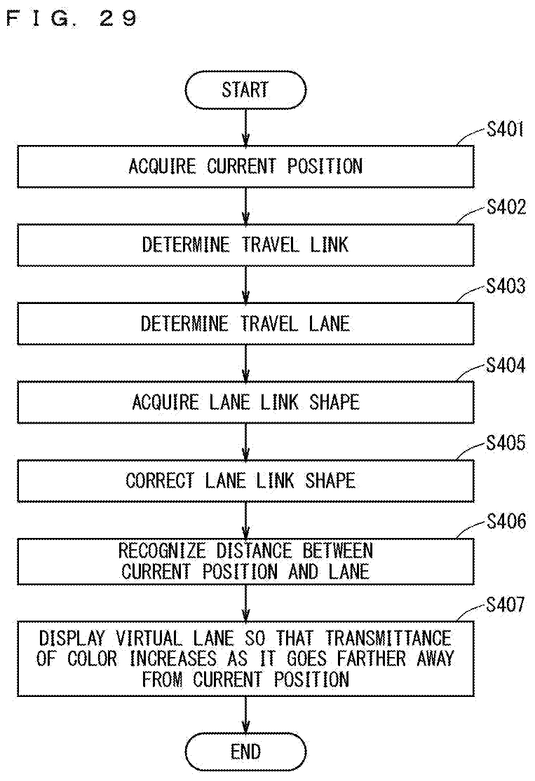

FIG. 29 is a flowchart showing an exemplary operation of the driver assistance apparatus 48. Further, since Steps S401 to S405 in FIG. 29 are the same as Steps S101 to S105 in FIG. 10, description thereof will be omitted herein. Hereinafter, Steps S406 and S407 will be described.

In Step S406, the distance recognition unit 49 recognizes the distance between the current position of the vehicle and the travel lane. Specifically, the distance recognition unit 49 recognizes the distance between the current position of the vehicle and the travel lane on the basis of the current position acquired by the current position acquisition unit 6 and the position of the travel lane acquired by the external information acquisition unit 7.

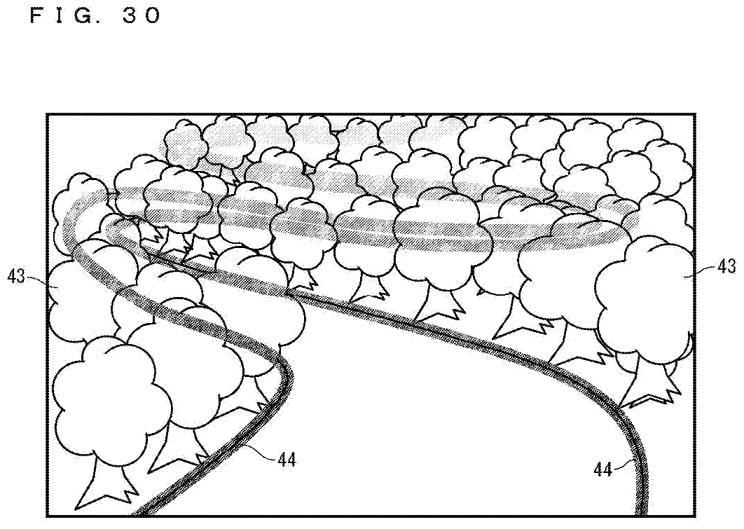

In Step S407, the display controller 4 performs control to display an image of the virtual lane on the head up display so that the transmittance of a color of the virtual lane should increase as it goes farther away from the current position of the vehicle. Specifically, as shown in FIG. 30, the display controller 4 controls the transmittance of the color of the virtual lane 44 to increase as it goes farther away from the current position of the vehicle.

Further, in the above Step S407, a range in which the virtual lane is displayed may be set in advance. In this case, a range within a predetermined distance out of distances between the current position of the vehicle and the travel lane, which is recognized by the distance recognition unit 49, may be the range in which the virtual lane is displayed.

Furthermore, though the above description has been made on the operation of the driver assistance apparatus 48, the navigation device 50 to which the driver assistance apparatus 48 is applied also performs the same operation.

The operation of FIG. 29 may start when an engine of the vehicle is turned on or may start in accordance with the instruction of the user.

As described above, according to the fourth preferred embodiment, the image of the virtual lane is displayed on the head up display so that the transmittance of a color of the virtual lane should increase as it goes farther away from the current position of the vehicle. Since the driver can thereby easily grasp the perspective of the virtual lane, the driver can drive the vehicle without confusion by preventing the loss of perspective. In other words, it becomes possible to increase the visibility of the travel lane for the driver. Further, by determining the range in which the virtual lane is displayed, it is possible to reduce the number of virtual lanes to be displayed and reduce the processing load in the driver assistance apparatus. Furthermore, by determining the range in which the virtual lane is displayed and performing a display so that the transmittance of the color of the virtual lane should increase as it goes farther away from the current position of the vehicle, it is possible to represent the border between the inside and the outside of a display range of the virtual lane more naturally.

Further, in the case where the driver assistance apparatus is applied to the navigation device, it is possible for the driver to easily grasp the shape of the travel lane in a portion on a route, which is hidden by a shielding object.

### The Fifth Preferred Embodiment

<Constitution>

As the characteristic feature of the fifth preferred embodiment, a virtual lane having the same color as that of the travel lane is displayed. Since respective constitutions of the driver assistance apparatus and the navigation device to which the driver assistance apparatus is applied in accordance with the fifth preferred embodiment are identical to those in the first preferred embodiment, description thereof will be omitted herein. Hereinafter, description will be made, assuming that the driver assistance apparatus and the navigation device in the fifth preferred embodiment are the driver assistance apparatus 5 and the navigation device 12 in the first preferred embodiment.

<Operation>

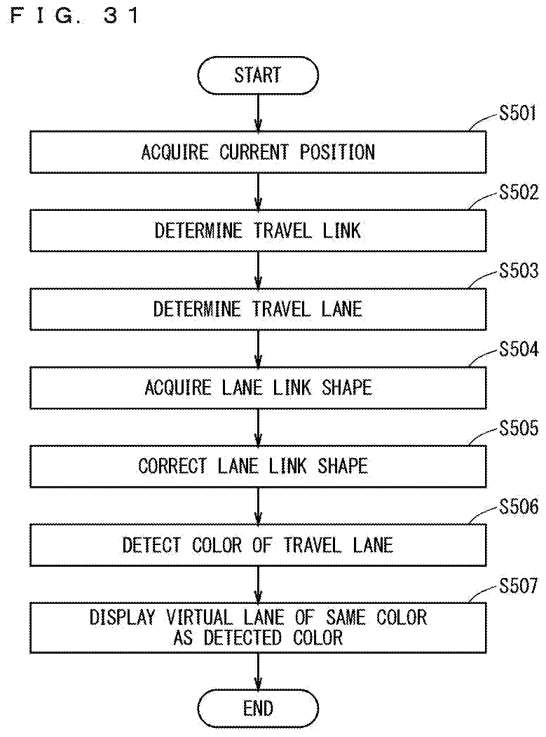

FIG. 31 is a flowchart showing an exemplary operation of the driver assistance apparatus 5 in the fifth preferred embodiment. Further, since Steps S501 to S505 in FIG. 31 are the same as Steps S101 to S105 in FIG. 10, description thereof will be omitted herein. Hereinafter, Steps S506 and S507 will be described.

In Step S506, the controller 11 detects a color of the travel lane. Herein, the color of the travel lane to be detected is a color of the travel lane which is acquired by the external information acquisition unit 7. The color of the travel lane which is acquired by the external information acquisition unit 7 is obtained by performing image processing of the image picked up by the outer-vehicle camera 28.

In Step S507, the display controller 4 performs control to display an image of the virtual lane having the same color as that of the travel lane on the head up display. Specifically, when the travel lane is white, the display controller 4 performs control to display a white virtual lane on the head up display. Further, when the travel lane is orange, the display controller 4 performs control to display an orange virtual lane on the head up display.

Further, though description has been made on the case where the color of the travel lane is acquired by the external information acquisition unit 7 in the above Step S506, this is only one exemplary case. For example, the map information acquisition unit 2 may acquire the carriageway marking line information included in the map information.

Further, though the above description has been made on the operation of the driver assistance apparatus 5, the navigation device 12 to which the driver assistance apparatus 5 is applied also performs the same operation.

The operation of FIG. 31 may start when an engine of the vehicle is turned on or may start in accordance with the instruction of the user.

As described above, according to the fifth preferred embodiment, the virtual lane having the same color as that of the travel lane is displayed on the head up display. It is thereby possible to prevent confusion or misunderstanding about traffic rules due to the difference in the color between the travel lane and the virtual lane. In other words, it becomes possible to increase the visibility of the travel lane for the driver.

Further, in the case where the driver assistance apparatus is applied to the navigation device, it is possible for the driver to easily grasp the shape of the travel lane in a portion on a route, which is hidden by a shielding object.

Furthermore, though the fifth preferred embodiment has been described above by using the driver assistance apparatus 5 and the navigation device 12 in the first preferred embodiment, the fifth preferred embodiment can be applied to the second to fourth preferred embodiments.

The driver assistance apparatus described above can be applied not only to an in-vehicle navigation device, i.e., a car navigation device, but also to a navigation device or a device other than a navigation device which is configured as a system by appropriately combining a Portable Navigation Device (PND) which is mountable on a vehicle, a server provided outside the vehicle, or the like. In this case, the functions or the constituent elements of the driver assistance apparatus are dispersed separately into the functions constituting the above-described system.

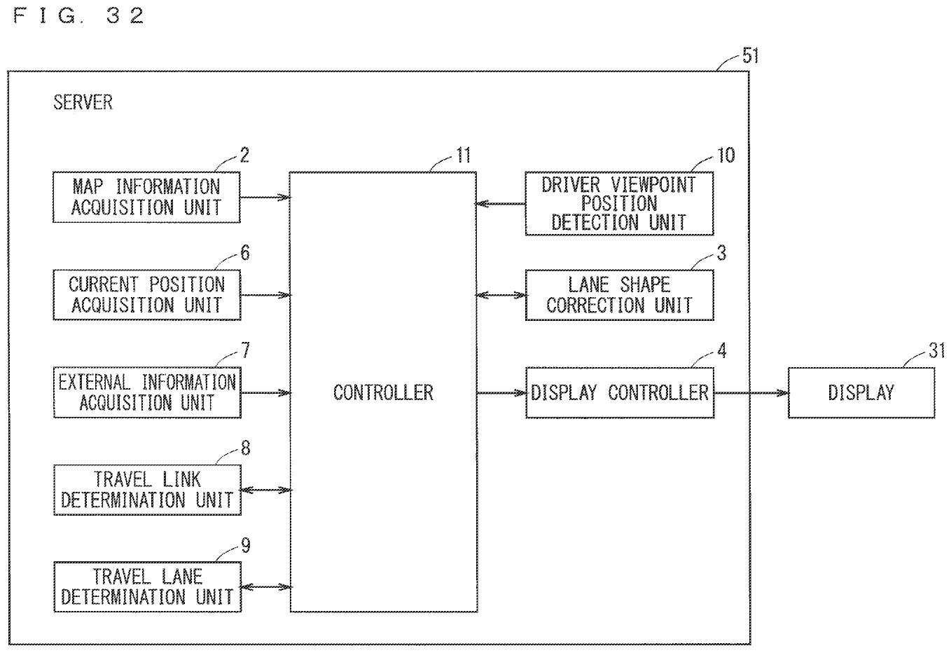

Specifically, as one example, the functions of the driver assistance apparatus can be provided in a server. As shown in FIG. 32, for example, the user side comprises the display 31. A server 51 comprises the map information acquisition unit 2, the lane shape correction unit 3, the display controller 4, the current position acquisition unit 6, the external information acquisition unit 7, the travel link determination unit 8, the travel lane determination unit 9, the driver viewpoint position detection unit 10, and the controller 11. With this constitution, a driver assistance system can be configured. The same applies to the driver assistance apparatus 45 of FIG. 19 and the driver assistance apparatus 48 of FIG. 27.

Even in the configuration where the respective functions of the driver assistance apparatus are dispersed separately into the functions constituting the system, the same effects as those in the above-described preferred embodiments can be produced.

Further, the software for performing operations in the above-described preferred embodiments may be incorporated in, for example, the server. A driver assistance method implemented by causing the server to execute the software comprises the steps of acquiring map information including a lane shape in a traveling direction of a vehicle, so correcting the acquired lane shape as to coincide with a position of a lane which a driver of the vehicle can actually visually recognize in his visual field, and performing control to so display an image of a virtual lane having the corrected lane shape as to be superimposed on the lane which the driver can actually visually recognize in his visual field, and in the driver assistance method, the control is performed to display the image of the virtual lane at least in a portion which the driver is impeded from actually visually recognizing in his visual field.

Thus, by incorporating the software for performing the operations in the above-described preferred embodiments into the server and operating the server, the same effects as those in the above-described preferred embodiments can be produced.

In the present invention, the preferred embodiments may be freely combined, or may be changed or omitted as appropriate, without departing from the scope of the invention.

While the invention has been shown and described in detail, the foregoing description is in all aspects illustrative and not restrictive. It is therefore understood that numerous modifications and variations can be devised without departing from the scope of the invention.

### Explanation of Reference Signs

1 driver assistance apparatus, 2 map information acquisition unit, 3 lane shape correction unit, 4 display controller, 5 driver assistance apparatus, 6 current position acquisition unit, 7 external information acquisition unit, 8 travel link determination unit, 9 travel lane determination unit, 10 driver viewpoint position detection unit, 11 controller, 12 navigation device, 13 audio data acquisition unit, 14 traffic information acquisition unit, 15 operation input unit, 16 voice recognition unit, 17 audio output controller, 18 route search unit, 19 route guidance unit, 20 controller, 21 control unit, 22 map information storage, 23 audio data storage, 24 GNSS receiver, 25 direction sensor, 26 distance sensor, 27 acceleration sensor, 28 outer-vehicle camera, 29 in-vehicle camera, 30 traffic information receiver, 31 display, 32 input device, 33 audio output device, 34 microphone, 35 CPU, 36 ROM, 37 RAM, 38 display controller, 39 input/output controller, 40 D/A converter, 41 amplifier, 42 speaker, 43 shielding object, 44 virtual lane, 45 driver assistance apparatus, 46 shielded lane detection unit, 47 navigation device, 48 driver assistance apparatus, 49 distance recognition unit, 50 navigation device, 51 server

1. A driver assistance apparatus comprising:
a processor to execute a program; and
a memory to store the program which, when executed by processor, performs processes of,
a map information acquisition process for acquiring map information including a lane shape in a traveling direction of a vehicle;
a lane shape correction process for so correcting the acquired lane shape as to coincide with a position of a lane which a driver of the vehicle can actually visually recognize in his visual field; and
a display controlling process for performing control to so display an image of a virtual lane having the corrected lane shape as to be superimposed on the lane which the driver can actually visually recognize in his visual field,
wherein the display controlling process comprises performing control to display the image of the virtual lane at least in a portion which the driver is impeded from actually visually recognizing in his visual field.

2. The driver assistance apparatus according to claim 1, wherein
the display controlling process comprises controlling a color of the virtual lane displayed in the portion to be different from that of the portion.

3. The driver assistance apparatus according to claim 1, wherein
the display controlling process comprises controlling a color rimming the virtual lane displayed in the portion to be different from a color of the portion.

4. The driver assistance apparatus according to claim 1, wherein
the display controlling process comprises controlling the transmittance of a color of the virtual lane displayed in the portion to be different from that of the virtual lane displayed in other than the portion.

5. The driver assistance apparatus according to claim 1, wherein
the display controlling process comprises performing control to display the virtual lane of luminescent color when the brightness outside the vehicle is not higher than a predetermined reference value.

6. The driver assistance apparatus according to claim 1, wherein
the display controlling process comprises controlling the transmittance of a color of the virtual lane to increase as it goes farther away from the vehicle.

7. The driver assistance apparatus according to claim 1, wherein
the display controlling process comprises performing control to display the image of the virtual lane within a predetermined distance from the vehicle.

8. The driver assistance apparatus according to claim 1, wherein
the display controlling process comprises performing control to display the image of the virtual lane having the same color as that of the lane which the driver of the vehicle can actually visually recognize in his visual field.

9. The driver assistance apparatus according to claim 1, wherein
the portion includes at least a building, a road structural object, a road structure, and nature.

10. A driver assistance method, comprising:
acquiring map information including a lane shape in a traveling direction of a vehicle;
so correcting the acquired lane shape as to coincide with a position of a lane which a driver of the vehicle can actually visually recognize in his visual field; and
performing control to so display an image of a virtual lane having the corrected lane shape as to be superimposed on the lane which the driver can actually visually recognize in his visual field,
wherein the control is performed to display the image of the virtual lane at least in a portion which the driver is impeded from actually visually recognizing in his visual field.
